(19) United States
(12) Patent Application Publication
(10) Pub. No.: US 2009/0327019 A1
(43) Pub. Date: Dec. 31, 2009

(54) MEETING SCHEDULING SYSTEM

(75) Inventors: Martinez Vencia Addae, Falls Church, VA (US); Fang Lu, Billerica, MA (US); Vandana Mallempati, Austin, TX (US); Jehan Moghazy, Arlington, VA (US)

Correspondence Address: IBM CORPORATION (RVW), C/O ROBERT V. WILDER, ATTORNEY AT LAW, 4235 KINGSBURG DRIVE, ROUND ROCK, TX, 78681, US

(73) Assignee: INTERNATIONAL BUSINESS MACHINES CORPORATION, Armonk, NY (US)

(21) Appl. No.: 12/145,631

(22) Filed: Jun. 25, 2008

(51) Int. Cl. G06Q 10/00

(52) U.S. Cl. 705/9

(57) ABSTRACT

A method, programmed medium and system are provided in which a user has an option to prioritize meetings and individuals who have access to the user's calendar. The disclosed exemplary embodiments provide for prioritizing meetings and allowing a certain set of favorite people see the availability based on priority. Users are enabled to designate specific individuals and corresponding priority levels for the designated individuals who have access to the user's calendar. A high priority user is enabled to schedule a meeting on other users' calendars based on the priority level of the scheduling user. The system automatically determines the priority level of the scheduling user and displays calendars of other invited users by displaying only other scheduled meetings which have a higher priority level thereby enabling automatic priority level scheduling for all users of the calendar system.

### FIELD OF THE INVENTION

The present invention relates generally to information processing systems and more particularly to a methodology and implementation for scheduling meetings in calendar applications.

### BACKGROUND OF THE INVENTION

Today, in most calendar applications, once a user accepts a meeting invitation, the user's calendar shows the time of the meeting as unavailable to others who have access to the user's calendar and who may also wish to schedule a meeting at that time. Since more important meetings are not always placed on a user's calendar before other meetings on the user's calendar, this presents a problem. For example, in many cases, when a business crisis arises, a user's manager may need to schedule a meeting with the user and others with very little prior notice of the meeting. In that case, when an attempt is made to schedule a last-minute relatively important meeting, the calendars of those who would be invited may show that all possible time slots are already taken by other, relatively less important meetings. In that situation, the only recourse is to contact the individuals who would be invited to the meeting, determine the importance of the other already scheduled meetings, and attempt to agree on a time for the last-minute, but very important meeting. This becomes quite time-consuming and burdensome, if not impossible, when a relatively large number of invited attendees is involved.

Thus, there is a need to provide a meeting scheduling methodology and system by which meetings can be scheduled according to a priority level thereby enabling more important meetings to be easily scheduled on otherwise unavailable times and dates.

### SUMMARY OF THE INVENTION

A method, programmed medium and system are provided in which a user has an option to prioritize meetings and individuals who have access to the user's calendar. The disclosed exemplary embodiments provide for prioritizing meetings and allowing a certain set of favorite people see the availability based on priority. Users are enabled to designate specific individuals and corresponding priority levels for the designated individuals who have access to the user's calendar. A high priority user is enabled to schedule a meeting on other users' calendars based on the priority level of the scheduling user. The system automatically determines the priority level of the scheduling user and displays calendars of other invited users by displaying only other scheduled meetings which have a higher priority level thereby enabling automatic priority level scheduling for all users of the calendar system. Thus higher priority meetings are scheduled even though there may be a conflict with an existing lower priority meeting. The scheduling user is not shown the lower priority meetings which facilitates the scheduling of higher priority meeting. When a conflict is created with a lower priority meeting scheduled for the same time, the invitee is made aware of the conflict and can proceed to re-schedule the lower priority meeting.

### BRIEF DESCRIPTION OF THE DRAWINGS

A better understanding of the present invention can be obtained when the following detailed description of a preferred embodiment is considered in conjunction with the following drawings, in which:

FIG. 1 is an illustration of one embodiment of a system in which the present invention may be implemented;

FIG. 2 is a block diagram showing several of the major components of a server in accordance with the present invention;

FIG. 3 is an illustration of an exemplary displayed application screen for enabling a user to designate individuals and assign a priority level to the designated individuals for scheduling meetings on a user's calendar;

FIG. 4 is an illustration of a priority level database useful in an exemplary implementation of the present invention;

FIG. 5 is an exemplary meeting schedule as viewed by a user of a calendar system in accordance with the present invention;

FIG. 6 is the meeting schedule of FIG. 5 as viewed by the user's manager;

FIG. 7 is the meeting schedule of FIG. 5 as viewed by the user's manager after the manager has input the manager's meeting;

FIG. 8 is an exemplary meeting schedule as viewed by a user of a calendar system after the user's manager has scheduled the meeting as shown in FIG. 7; and

FIG. 9 is a flow chart illustrating an exemplary sequence of operations which may be implemented in accordance with the present invention.

### DETAILED DESCRIPTION

The various methods discussed herein may be implemented within a computer system which includes processing means, memory, updateable storage, input means and display means. Since the individual components of a computer system which may be used to implement the functions used in practicing the present invention are generally known in the art and composed of electronic components and circuits which are also generally known to those skilled in the art, circuit details beyond those shown are not specified to any greater extent than that considered necessary as illustrated, for the understanding and appreciation of the underlying concepts of the present invention and in order not to obfuscate or distract from the teachings of the present invention. Although the invention is illustrated in the context of a networked calendar application, it is understood that disclosed methodology may also be applied in stand-alone systems and many other available and future devices and systems to achieve the beneficial functional features described herein.

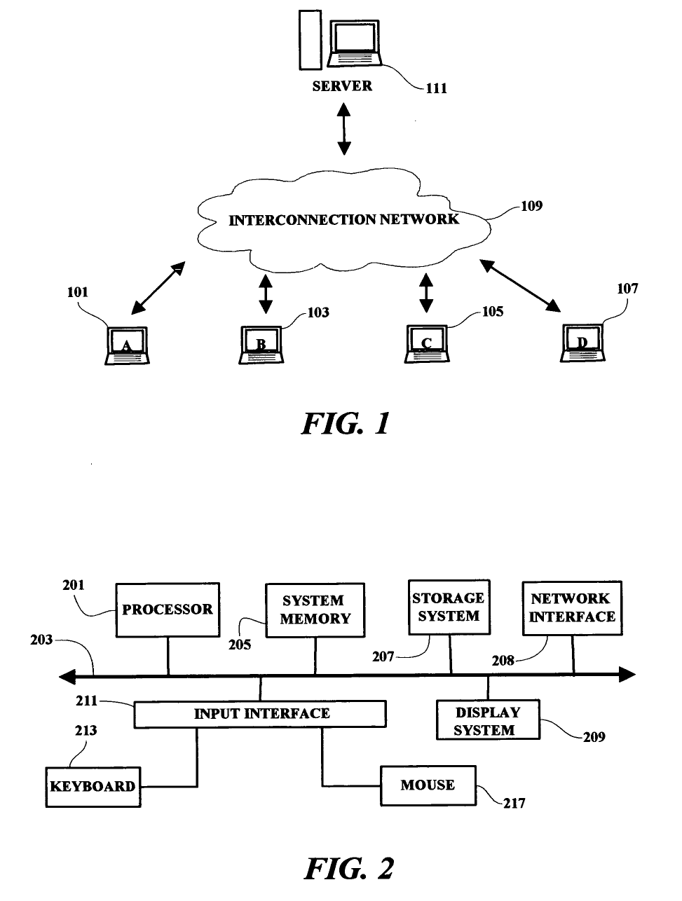

FIG. 1 illustrates an exemplary environment in which the present invention may be implemented. As shown, a plurality of user terminals 101, 103, 105 and 107 are configured to enable users A, B, C and D, respectively, to communicate through an interconnection network 109 to a server 111. The interconnection network may be the Internet or any local or wide area network, either hard-wired or wireless or any combination of the above or other technologies. Further, in the example, a calendar program is running on the server 111 and accessed from the user terminals 101, 103, 105 and 107.

FIG. 2 illustrates several of the major components of a computer system, both the server and the user terminals, which may be used to implement the present invention. As shown, a processor unit 201 is connected to a main bus 203. The main bus 203 is also coupled to, inter alia, system memory 205, a storage system 207, a network interface 208, an input interface 211 including connections to a keyboard 213 and a mouse or pointing device 217. The main bus is also connected to a display system 209.

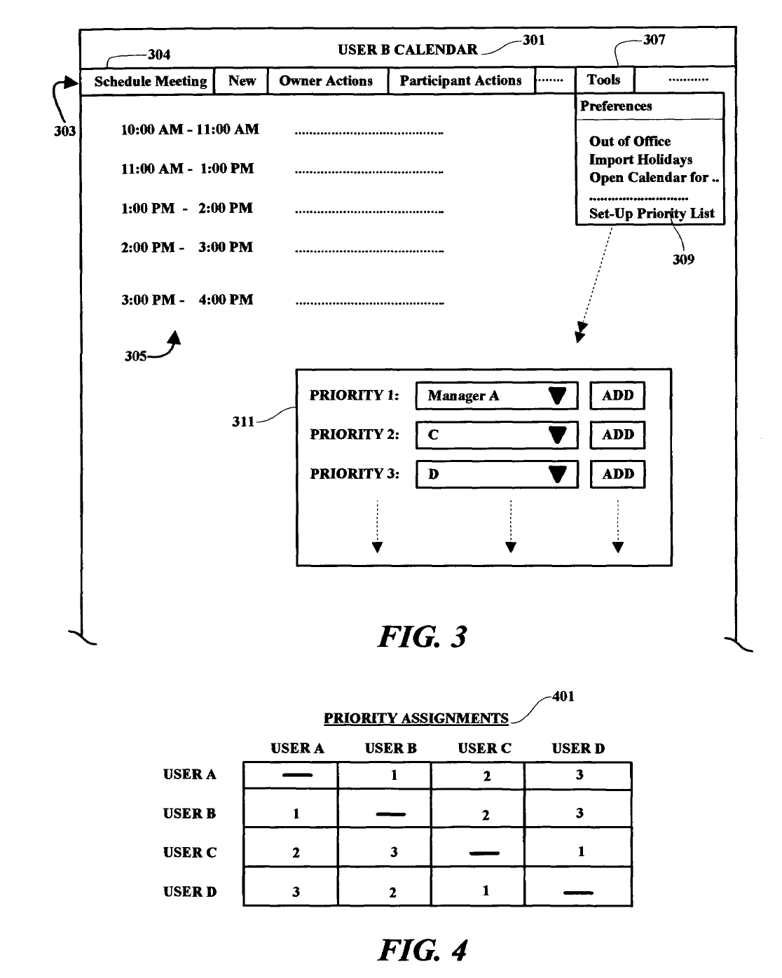

In the present example, a calendar program which is accessible by all of the users A, B, C and D, contains the calendar meeting schedules for all of the users. In an exemplary implementation, every user of a calendar program can give a priority to the meeting invitations they accept. They can also setup a list of people who can see the user's availability based on the priority. For example, as shown in FIG. 3, User B's Calendar 301 includes a listing of scheduled meetings 305 as well as various calendar functions 303, including a “Schedule Meeting” function and a “Tools” selection 307. In the disclosed example, under “Tools” and “Preferences”, another selection “Set-Up Priority List” 309 is included. It is understood that the priority function may be accessed through many other menu selections in any given calendar program. When the “Set-Up Priority List” item is selected by user B, the window 311 is presented to enable the user to select and input priorities which are associated with certain individuals and used in scheduling meetings to which user B may be invited. In the example, user B has designated B's manager A as having a “PRIORITY 1” status. B has also input user C with a “PRIORITY 2” status and user D with a “PRIORITY 3” status. That means, in scheduling invitations and meetings on user B's calendar, A has top priority, followed by C and D, respectively.

As a result of B's set-up, a data base or listing of Priority Assignments 401, including individual users and their corresponding priority levels, is established for each of the users as shown in FIG. 4. This listing is accessed by the calendar server whenever one of the users, i.e. a “requesting user”, attempts to or requests to schedule a meeting on another user's calendar to insure that the most important meetings get scheduled ahead of other meetings which may not be so important in accordance with the priority levels assigned by B. The priority levels may also be set-up to be assigned to types of meetings as well as to individuals as shown. For example, “product review” meetings may have priority over “staff meetings” especially as a product release date approaches.

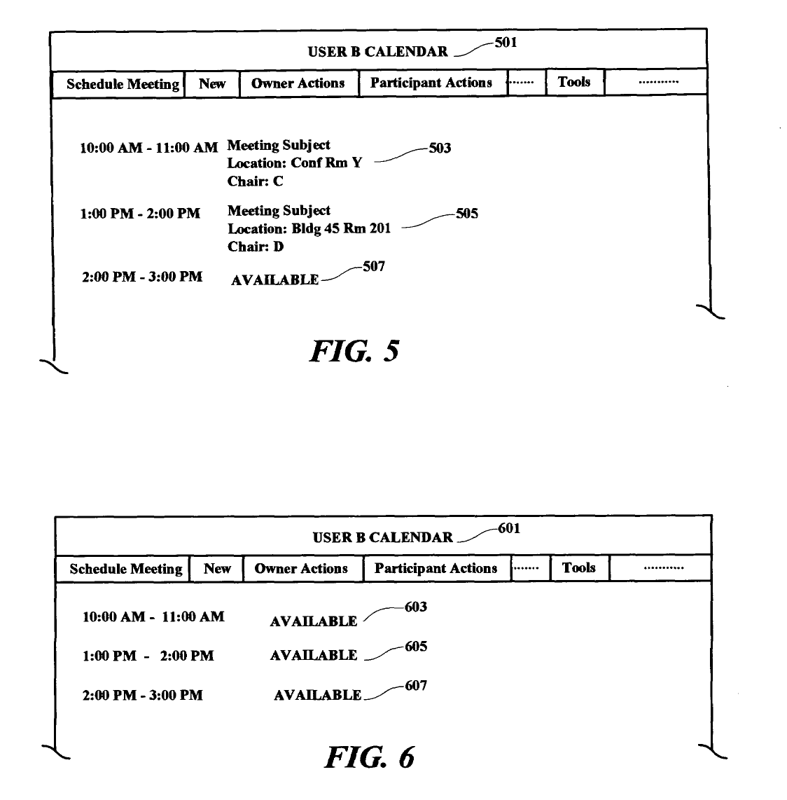

FIG. 5 is an example of how user B's calendar 501 is displayed to user B at a given point in time. As illustrated, a meeting 503 for which C is Chairperson has been scheduled on B's calendar for 10 AM to 11 AM and a meeting 505 for which D is Chairperson has been scheduled for 2 PM to 3 PM. It is noted that, referring to FIG. 3, B has assigned a Priority “2” to user C and a priority “3” to user D. As shown in FIG. 5, the time slot between 2 PM and 3 PM is shown as “Available” 507 since no meetings have been scheduled for that time.

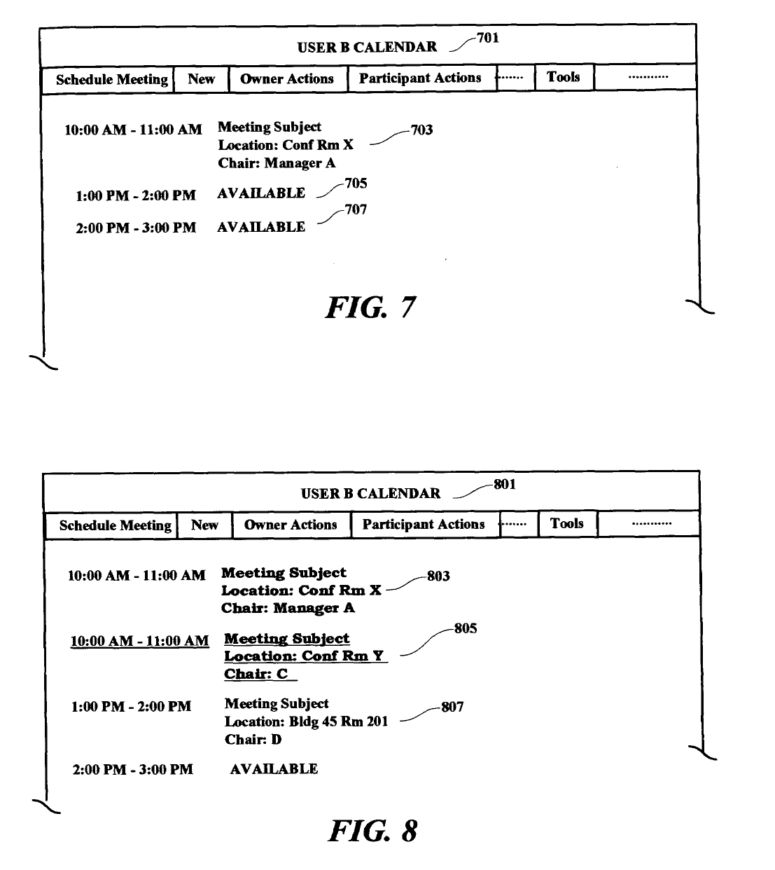

For purposes of illustrating an exemplary operation of the present invention, it is assumed that B's manager A wishes to schedule or invite B to an urgent meeting and the only time slot available to A is the one hour between 10 AM and 11 AM. According to the present invention, A is enabled to schedule a meeting on B's calendar for that time slot even though C's meeting had been scheduled earlier. When A accesses B's calendar, A will see B's calendar 601 as shown in FIG. 6 with all time slots 10 AM to 11 AM 603, 1 PM to 2 PM 605 and 2 PM to 3 PM 607 as “Available”. The existing scheduled meetings with C and D will not be displayed to A since A has a higher priority and is enabled to schedule a meeting in time slots previously taken by lower priority meeting. Thus, as shown in FIG. 7, A is enabled to schedule A's meeting for between 10 AM and 11 AM 703 on B's calendar 701, and, as viewed by A, B's calendar continues to show “Available” time slots 705 and 707 for other times on B's calendar over which A has priority.

As shown in FIG. 8, B's calendar 801 as viewed by B after A has scheduled his priority meeting 803 shows a conflict situation where two meetings 803 and 805 have been scheduled for the same time slot 10 AM to 11 AM. Being aware that A has priority, B is enabled to reschedule the meeting with C for another time slot and advise C accordingly. The calendar program may include a function for various methods of highlighting the schedule conflict such a emboldening or underscoring the lower priority meeting 805, or higher priority meeting 803, in order to notify B that a re-scheduling is necessary. An active audible notification system such as an alarm, or an active visual alarm or notification system such as blinking text may also be implemented to notify B that a conflict exists. The previously scheduled meeting with D remains unchanged at 1 PM as does the “Available” time slot form 2 PM to 3 PM. In applications where an acceptance of an invitation to a meeting is required or enabled, the acceptance function would be implemented before the meeting schedule is finalized.

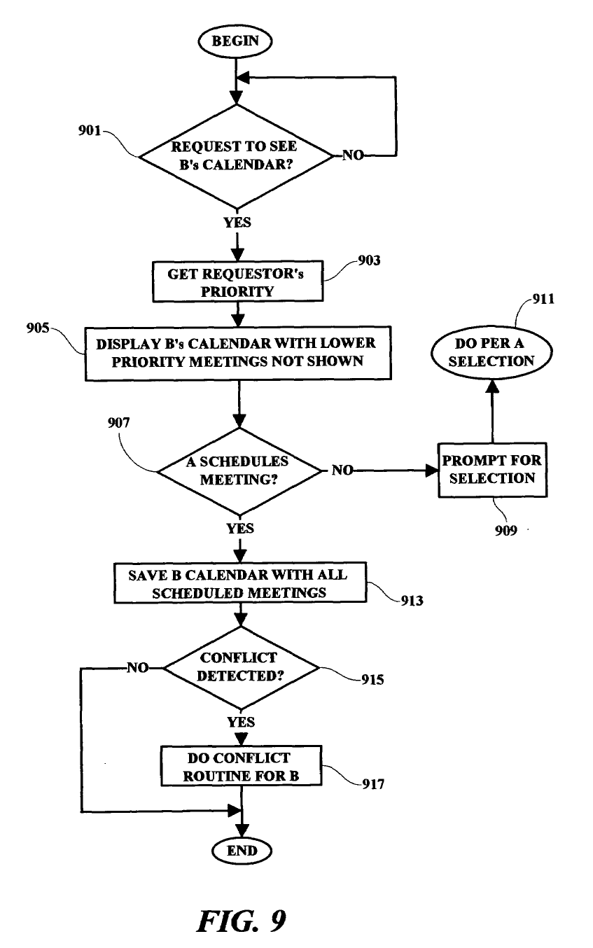

FIG. 9 shows a flow chart to illustrate an exemplary operational processing sequence. As shown, when a request to see B's calendar is received 901, the requester's priority is obtained 903 from B's priority listing and B's calendar is displayed to the requester without showing 905, or showing as “Available”, any meetings or time slots previously scheduled or existing at a priority lower than the priority of the requester. If the requester (A) does not schedule a meeting on B's calendar, then a display will prompt A for a selection 909 and proceed to process the selection made by A according to the calendar program 911. If however, A schedules a meeting on B's calendar 907, then the scheduled meeting with A is saved 913 along with all of the other scheduled meetings as shown in FIG. 8. If there is no meeting conflict detected 915, then the processing ends. However, if a conflict of scheduled meetings is detected 915 then the processing continues in order to perform a conflict resolution routine 917 before ending the process. As noted earlier, an example of such a conflict resolution routine would be to highlight the conflict in some manner such that B is notified of the conflict and enabled to reschedule the lower priority meeting. This function could also be easily implemented automatically to re-schedule the meeting with C at the next available time slot of B, subject to acceptance of the re-scheduled meeting time from the other participants.

The method and apparatus of the present invention has been described in connection with a preferred embodiment as disclosed herein. The disclosed methodology may be implemented in a wide range of sequences, menus and screen designs to accomplish the desired results as herein illustrated. Although an embodiment of the present invention has been shown and described in detail herein, along with certain variants thereof, many other varied embodiments that incorporate the teachings of the invention may be easily constructed by those skilled in the art, and even included or integrated into a processor or CPU or other larger system integrated circuit or chip. The disclosed methodology may also be implemented solely or partially in program code stored in any media, including any portable or fixed, volatile or non-volatile memory media device, including CDs, RAM and “Flash” memory, or other semiconductor, optical, magnetic or other memory storage media from which it may be loaded and/or transmitted into other media and executed to achieve the beneficial results as described herein. Accordingly, the present invention is not intended to be limited to the specific form set forth herein, but on the contrary, it is intended to cover such alternatives, modifications, and equivalents, as can be reasonably included within the spirit and scope of the invention.

What is claimed is:

1. A method for processing scheduling of meetings in a user's calendar application, said method comprising:
enabling a first user to designate a priority level to meetings to be requested by a requesting user of said calendar application on said first user's meeting schedule; and
enabling said requesting user to schedule meetings on said first user's meeting schedule in accordance with said priority level assigned by said first user whereby said requesting user is enabled to schedule meetings in place of previously scheduled but lower priority level meetings on said first user's meeting schedule.

2. The method as set forth in claim 1 wherein said requesting user is enabled to view said meeting schedule of said first user when requesting a meeting at a selected time on said first user's meeting schedule, said meeting schedule of said first user being presented to said requesting user such that only currently scheduled meetings associated with a priority level equal to or higher than a priority level of said requesting user are displayed to said requesting user.

3. The method as set forth in claim 1 wherein said requesting user is enabled to view said meeting schedule of said first user when requesting a meeting at a selected time on said first user's meeting schedule, said meeting schedule of said first user being presented to said requesting user such that only currently scheduled meetings associated with a priority level higher than a priority level of said requesting user are displayed to said requesting user.

4. The method as set forth in claim 1 wherein said first user is enabled to assign a selected priority level to other selected individual users of said calendar application.

5. The method as set forth in claim 1 wherein said first user is enabled to assign a selected priority level to selected types of meetings which may be scheduled on said first user's meeting schedule.

6. The method as set forth in claim 1 and further including providing an alarm indication to said first user when a meeting conflict has been created on said first user's meeting schedule.

7. A storage medium including machine readable coded indicia, said storage medium being selectively coupled to processing circuitry within a computer system, said processing circuitry being operable to provide program signals representative of said machine readable coded indicia, said program signals being selectively operable for processing scheduling of meetings in a user's calendar application by effecting the steps of:
enabling a first user to designate a priority level to meetings to be requested by a requesting user of said calendar application on said first user's meeting schedule; and
enabling said requesting user to schedule meetings on said first user's meeting schedule in accordance with said priority level assigned by said first user whereby said requesting user is enabled to schedule meetings in place of previously scheduled but lower priority level meetings on said first user's meeting schedule.

8. The medium as set forth in claim 7 wherein said requesting user is enabled to view said meeting schedule of said first user when requesting a meeting at a selected time on said first user's meeting schedule, said meeting schedule of said first user being presented to said requesting user such that only currently scheduled meetings associated with a priority level equal to or higher than a priority level of said requesting user are displayed to said requesting user.

9. The medium as set forth in claim 7 wherein said requesting user is enabled to view said meeting schedule of said first user when requesting a meeting at a selected time on said first user's meeting schedule, said meeting schedule of said first user being presented to said requesting user such that only currently scheduled meetings associated with a priority level higher than a priority level of said requesting user are displayed to said requesting user.

10. The medium as set forth in claim 7 wherein said first user is enabled to assign a selected priority level to other selected individual users of said calendar application.

11. The medium as set forth in claim 7 wherein said first user is enabled to assign a selected priority level to selected types of meetings which may be scheduled on said first user's meeting schedule.

12. The medium as set forth in claim 7 wherein said program signals are further effective for providing an alarm indication to said first user when a meeting conflict has been created on said first user's meeting schedule.

13. A calendaring system for processing scheduling of meetings in a user's calendar application, said calendaring system comprising:
a server configured for executing said user's calendar application;
a user terminal coupled to said server, said user terminal including means for enabling a first user to designate a priority level to meetings to be requested by a requesting user of said calendar application on said first user's meeting schedule; and
means for enabling said requesting user to schedule meetings on said first user's meeting schedule in accordance with said priority level assigned by said first user whereby said requesting user is enabled to schedule meetings in place of previously scheduled but lower priority level meetings on said first user's meeting schedule.

14. The system as set forth in claim 13 and further including means for enabling said requesting user to view said meeting schedule of said first user when requesting a meeting at a selected time on said first user's meeting schedule, said meeting schedule of said first user being presented to said requesting user such that only currently scheduled meetings associated with a priority level equal to or higher than a priority level of said requesting user are displayed to said requesting user.

15. The system as set forth in claim 13 and further including means for enabling said requesting user to view said meeting schedule of said first user when requesting a meeting at a selected time on said first user's meeting schedule, said meeting schedule of said first user being presented to said requesting user such that only currently scheduled meetings associated with a priority level higher than a priority level of said requesting user are displayed to said requesting user.

16. The system as set forth in claim 13 and further including means for enabling said first user to assign a selected priority level to other selected individual users of said calendar application.

17. The system as set forth in claim 13 and further including means for enabling said first user to assign a selected priority level to selected types of meetings which may be scheduled on said first user's meeting schedule.

18. The system as set forth in claim 13 and further including means for providing an alarm indication to said first user when a meeting conflict has been created on said first user's meeting schedule.

19. The system as set forth in claim 13 and further including means for enabling said requesting user to view said meeting schedule of said first user when requesting a meeting at a selected time on said first user's meeting schedule, said meeting schedule of said first user being presented to said requesting user such that only currently scheduled meetings associated with a priority level equal to or higher than a priority level of said requesting user are displayed to said requesting user, said system further including means for enabling said first user to assign a selected priority level to other selected individual users of said calendar application, said system further including means for enabling said first user to assign a selected priority level to selected types of meetings which may be scheduled on said first user's meeting schedule, said system further including means for providing an alarm indication to said first user when a meeting conflict has been created on said first user's meeting schedule.
